(19) United States
(12) Patent Application Publication
(10) Pub. No.: US 2024/0006740 A1
(43) Pub. Date: Jan. 4, 2024

(54) ANTENNA SYSTEM

(71) Applicants: AGC GLASS EUROPE, Louvain-la-Neuve (BE); AGC INC., Chiyoda Ku (JP); AGC FLAT GLASS NORTH AMERICA, INC., Alpharetta, GA (US); AGC VIDROS DO BRASIL LTDA, Sao Paulo (BR)

(72) Inventors: Mohsen YOUSEFBEIKI, Gosselies (BE); Rafik ADDACI, Gosselies (BE); Günther SALME, Gosselies (BE)

(73) Assignees: AGC GLASS EUROPE, Louvain-la-Neuve (BE); AGC INC., Chiyoda Ku (JP); AGC FLAT GLASS NORTH AMERICA, INC., Alpharetta, GA (US); AGC VIDROS DO BRASIL LTDA, Sao Paulo (BR)

(21) Appl. No.: 18/252,154

(22) PCT Filed: Nov. 16, 2021
(86) PCT No.: PCT/EP2021/081871

§ 371 Date: May 8, 2023

(30) Foreign Application Priority Data
Nov. 16, 2020 (EP) 20207890.3

(51) Int. Cl. H01Q 1/12; H01Q 9/04; H01Q 1/42; H01Q 1/48

(52) U.S. Cl. CPC H01Q 1/12; H01Q 9/0407; H01Q 1/422; H01Q 1/48

(57) ABSTRACT

An antenna system inscribed in a parallelepiped. The parallelepiped has an antenna system front face. The antenna system contains a first transparent dielectric panel in front of the antenna system front face and a second transparent dielectric panel in front of the first transparent dielectric panel and separated by at least one panel interlayer from the first transparent dielectric panel. The antenna system also contains a transparent antenna arrangement containing a patch network attached and separated by at least one patch interlayer from the first transparent dielectric panel, a feeding network attached and separated by at least one feed interlayer from the second transparent dielectric panel and a ground plane. The antenna system also contains an antenna housing. An associated method and use are disclosed.

### TECHNICAL FIELD

The present invention relates to an antenna system in general, and more specifically, to an antenna system comprising transparent antenna arrangement.

Thus, the invention concerns multiple domains where an antenna system is used.

### BACKGROUND ART

Mobile data traffic is increasing continuously and will boom significantly with 5G, putting mobile network operators under CAPEX pressure. Higher frequency bands for 5G mean more challenges for coverage deployment, especially in dense urban areas where capacity will be needed and strict EMF limitations apply. The deployment of small cells are described as a good solution for capacity improvement which requires to install a large number of antennas in order to stably perform electromagnetic wave transmission and reception. However, many drawbacks limit the deployment of small cells. First, it is very difficult to find location for new antennas. Second, bringing fiber and electricity outdoor is costly. Finally, urbanistic regulations may limit possibilities for small cells.

On the other hand, In recent years with miniaturization, antennas are increasingly installed in buildings. When installing the antenna in the building, it is necessary to select the proper placement of the antenna so that electromagnetic waves can be transmitted and received stably while preventing the appearance of the building from being impaired.

U.S. Pat. No. 5,322,143 describes a planar antenna having three conductive layers: a patch network, a ground and feeding network. The planar antenna can be integrated into a façade of a building using the glass panel as a carrier. The issue with such planar antennas, because integrated into the façade, is that at least the electrical connection, the installation and the maintenance is complicated and impossible to manage once the façade is on the building. On top of that, performance parameters of the planar antenna is limited by thicknesses of the components of the façade, such as glass panels, spacers, . . .

Therefore, with such planar antennas is not possible to change the frequency band or the optimize the transmission and/or reception of the antenna to meet the requirement of current and future communication systems.

### SUMMARY OF INVENTION

The present invention relates, in a first aspect, to antenna system inscribed in a parallelepiped. The parallelepiped has an antenna system front face. The antenna system comprises a first transparent dielectric panel in front of the antenna system front face and a second transparent dielectric panel in front of the first transparent dielectric panel and separated by at least one panel interlayer from the first transparent dielectric panel. The antenna system also comprises a transparent antenna arrangement comprising a patch network attached and separated by at least one patch interlayer from the first transparent dielectric panel, a feeding network attached and separated by at least one feed interlayer from the second transparent dielectric panel and a ground plane. The antenna system also comprises an antenna housing.

The solution as defined in the first aspect of the present invention is based on that the antenna housing comprises a first retaining means to retain the first transparent dielectric panel at a defined distance, Daf11, from the front face.

The solution as defined in the first aspect of the present invention is also based on that at least one patch interlayer is a transparent polymer interlayer.

The present invention relates, in a second aspect, to a method to optimize the transmission and/or the reception of an antenna system, according to the first aspect. The method comprises a step of defining the configuration of the window and/or the operating frequency and a step of adapting the distance Daf11 in the antenna housing.

Finally, the present invention also relates, in a third aspect, to the use of an antenna housing of an antenna system according to the first aspect to optimize the transmission and/or the reception of the antenna system mounted in front of a window.

It is noted that the invention relates to all possible combinations of features recited in the claims or in the described embodiments.

The following description relates to building applications but it's understood that the invention may be applicable to others fields like automotive or transportation applications.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic sectional view of an antenna system according to the invention.

FIG. 2 is a schematic sectional view of antenna arrangement according to some embodiments of the invention.

FIG. 3 is a schematic sectional view of antenna arrangement according to some embodiments of the invention.

FIG. 4 is a schematic 3D view of an antenna system according to a first embodiment mounted on a window.

FIG. 5 is a schematic side view of an antenna system according to a first embodiment.

FIG. 6 is a schematic teardown view of an antenna system according to a first embodiment.

FIG. 7 is a schematic 3D view of an antenna system according to a second embodiment mounted on a window.

FIG. 8 is a schematic side view of an antenna system according to a second embodiment.

### DETAILED DESCRIPTION

It is an object of the present invention to alleviate the above described problems and to remove the barriers to outdoor 4G and 5G network densification. Especially, the object of the first aspect of the present invention is to allow indoor installation of the antennas, eliminating the need for scaffolding or foundation work in the street. Another advantage of the present invention is that transparent antenna enables seamless indoor or outdoor placement in line with urban aesthetics and EMF constraints.

Another advantage of the present invention is to provide an efficient antenna system in front of a window as discrete as possible meaning that the antenna system is transparent or at least the antenna arrangement is transparent.

According to a first aspect of the invention, the invention relates to antenna system 1 inscribed in a parallelepiped 3. The parallelepiped has an antenna system front face 31.

Antenna system according to the invention have typically a weight of about 2 kg to 3 kg. The parallelepiped has typically a width and/or a length comprised between mm to 600 mm for example a rectangular shape of 210 mm×250 mm, a rectangular shape of 150 mm×160 mm or rectangular shape of 255 mm×500 mm depending of the operating frequencies, the number of antenna arrangements, the number of elements comprised in the antenna arrangement and/or the transparency design.

Preferably, the antenna system works for 4G and/or 5G, meaning wavelengths with frequencies from 690 MHz to 70 GHz.

The antenna system 1 comprises a first transparent dielectric panel 11 and a second transparent dielectric panel 12. The first transparent dielectric panel is in front of the antenna system front face 31. The second transparent dielectric panel 12 is in front of the first transparent dielectric panel 11.

The term “transparent” denotes a property illustrating the average TL (light transmission) of visible light transmitted through a material in the visible spectrum of at least 1%. Preferably, transparent relates to a TL property of at least 10%. More preferably, transparent denotes a TL of at least 50%. Ideally, transparent denotes a TL of at least 70%.

A dielectric panel is a panel that is not electrically conductive.

The first and the second transparent dielectric panels can have different chemical composition, such as plastic-based composition. The plastic-based composition can be PET, polycarbonate, PVC or any other transparent dielectric plastic-based that can be used as a panel.

Preferably, the first and/or the second transparent dielectric panel comprises a glass panel to protect the antenna arrangement and the antenna system from scratches. The glass panel can comprises at least 50% in weight of SiO2 such as glass like soda lime glass, aluminosilicate glass or borosilicate glass.

In some embodiments, the first and the second transparent dielectric panels have the same chemical composition to reduce the handling and the process of manufacturing.

Preferably, the first and the second transparent dielectric panels can have a loss tangent equals to or smaller than 0.03 and more preferably the loss tangent of the dielectric panels is equal to or smaller than 0.02 and more preferably the loss tangent of the dielectric panels is equal to or smaller than 0.01 to reduce the energy loss in panels while increasing the antenna system efficiency.

In preferred embodiments, the first and the second transparent dielectric panels have a loss tangent equals to or smaller than 0.005 and more preferably the loss tangent of the dielectric panels is equal to or smaller than 0.003 to reduce the energy loss in panels while increasing the antenna system efficiency.

Preferably, the first and the second transparent dielectric panels are borosilicate glass panels to reduce the loss tangent to a value equals to or is smaller than 0.01.

The dielectric panels can be manufactured by a known manufacturing method such as a float method, a fusion method, a redraw method, a press molding method, or a pulling method. As a manufacturing method of the glass panel, from the viewpoint of productivity and cost, it is preferable to use the float method.

Each transparent dielectric panel can be independently processed and/or colored, . . . and/or have different thickness in order to improve the aesthetic, safety, . . .

Each transparent dielectric panel can be processed, i.e. annealed, tempered, . . . to respect the specifications of security requirements. The transparent dielectric panel can independently be a clear or a colored transparent dielectric panel, tinted with a specific composition or by applying an additional coating or a plastic layer for example.

The first and the second transparent dielectric panels can have any shape. The shape of the transparent dielectric panels 11, 12 in a plan view is not limited to a rectangle and may be a trapeze, a triangle, a square, a circle or the like.

The first 11 and the second 12 transparent dielectric panels are separated by at least one panel interlayer 13.

In some embodiments, the first 11 and the second 12 transparent dielectric panels can be separated to create a space 13 filled by a gas like Air. In such embodiments, the at least one panel interlayer 13 is the gas gap. Being understood that the first 11 and the second 12 transparent dielectric panels can be separated by the gas gap and at least one another interlayer.

In some embodiments, the first 11 and the second 12 transparent dielectric panels can be laminated together. In such embodiments, the at least one panel interlayer 13 is a interlayer able to laminate the first 11 and the second 12 transparent dielectric panels together. Preferably, such panel interlayers can be transparent plastic interlayers. Transparent plastic interlayer can be polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane, an acrylonitrile butadiene styrene copolymer (ABS), a styrene acrylonitrile copolymer (SAN), a styrene methyl methacrylate copolymer (SMMA) and any mixtures of these, a crosslinked resin, an ionoplast, an ionomer, a cyclo-olefin polymer (COP), cyclo-Olefin copolymer (COC) or an Optical Clear Adhesive (OCA).

Crosslinked or cured resins are known to the skilled person and are three dimensional polymer networks obtained by the crosslinking/curing of low molecular weight species either by reaction with a curing agent also known as crosslinker or upon exposure to heat, UV radiations (UV) or electron beam (EB). Non exhaustive examples of crosslinked resins are epoxy resins, polyurethane resins, UV or EB curable resins. In the present invention, the precursors of the crosslinked resin may be transparent or not provided that the crosslinked resin is transparent.

Remark that some polymer mixtures, copolymers and some semi-crystalline polymers can be opaque and non-transparent due to a dispersed phase or due to the presence of crystallites. Hence it is possible that not all compositions of the listed polymers mentioned above are transparent. The person skilled in the art is capable to identify what composition is transparent and hence identify if a given polymer falls within the claimed transparent polymers.

The term “in front of” denotes that the first transparent dielectric panel is facing the antenna system front face, the second transparent dielectric panel is facing the first transparent dielectric panel.

In some embodiments, the first transparent dielectric, the second transparent dielectric and/or installation interface panel, if it presents, are not parallel to each other. Preferably, surfaces of the first and the second panels are parallel and the first 11 and the second 12 transparent dielectric panels are parallel and aligned to each other and parallel and aligned to the antenna system front face 31 to simplify the antenna system design and fabrication while decreasing the antenna system profile.

Preferably, the antenna system radiates towards a specific direction through the antenna system front face to emit and/or receive through a window and to cover terminals outside a building for instance.

The antenna system 1 also comprises a antenna housing 40. The antenna housing comprises a first retaining means 41 to retain the first transparent dielectric panel 11 at a defined distance, Daf11, from the front face 31.

In some embodiments, the antenna system 1 can comprise an installation interface panel 14 located between the first dielectric panel 11 and the antenna system front face 31. The installation interface panel permits to cancels out the impact of the installation medium/media on the antenna system performance and permits to maintain the impedance response of the antenna as well as the radiation properties of the antenna within the specifications. In some embodiments, the installation interface panel can add more functionalities to the antenna system, such as the beam steering or beam shaping.

The installation interface panel 14 can comprise at least a transparent dielectric panel such as glass and/or plastic. In some embodiments. At least a conductive pattern can be deposited on at least one of dielectric panels.

In some preferred embodiments, the antenna housing comprises a second retaining means 42 to retain the installation interface panel 14 at a defined distance, Dafm, from the antenna system front face 31.

Preferably, the installation interface panel 14 is parallel to the antenna system front face 31 to simplify the design and fabrication of the installation interface panel.

Preferably, in the second aspect of the present invention, the method comprises a step of defining the configuration of the window and a step of adapting the defined distance Dafm in the antenna housing to optimize the reception and/or the transmission of the antenna system.

In some embodiments, retaining means 41, 42, 43 can have a profile shape adapted to retain the corresponding panel.

In some embodiments, the first 41 and the third 43 retaining means are a single retaining means to adapt in one step the defined distances Daf11 and Daf12 meaning that the defined distances Daf11 and Daf12 are adapted by the same difference meaning that in case of Daf11 is adapted by a distance d, Daf12 is also adapted by the same distance d.

In some embodiments, the first and/or the second and/or the third retaining means can comprise an adjustable means to modify the defined distance between the antenna system front face and respectively the first transparent dielectric panel, the matching panel and the second transparent dielectric panel to optimize the reception and/or transmission of the antenna system.

In some embodiments, each retaining means can independently adapt the defined distance Daf11, Dafm and Daf12.

Preferably, the defined distance Dafm is between 1 mm and-10 mm.

Preferably, the defined distance Daf11 is between 1/10 of the wavelength, more preferably ⅛ of the wavelength, and ½ of the wavelength meaning that preferably the defined distance Daf11 equals to or is higher than 10 mm for 4G and 5G.

Preferably, the defined distance Daf12 is between equals to or is higher than 15 mm up to preferably 70 mm. it is understood that Dafm<Daf11<Daf12.

Preferably, the difference between the patch network and the feeding network is substantially comprises between 40 and 100 mm, more preferably is substantially comprises between 45 and 8 mm, and much more preferably is substantially comprises between 48 and 68 mm.

In some preferred embodiments, the retaining means comprises a recess wherein respectively the first transparent dielectric, the second transparent dielectric and/or installation interface panel is retained. In some embodiments, the recess can have a width larger than the thickness of the sum of thickness of the corresponding the first transparent dielectric, the second transparent dielectric and/or installation interface panel with the layers attached to it to be able to insert and retain the panel.

In some embodiments, retaining means 41, 42, 43 can have a mobile part, such a screw, able to adapt the corresponding defined distance Daf11, Dafm and Daf12 inside the corresponding recess.

In some embodiments, to modify the defined distance, the retaining means can allow to retain different panel thicknesses. By modifying the thickness of the first transparent dielectric, the second transparent dielectric and/or installation interface panel to optimize the transmission and/or the reception of the antenna system.

The antenna system 1 also comprises a transparent antenna arrangement 10 comprising a patch network P attached and separated by at least one patch interlayer Ip from the first transparent dielectric panel 11.

The at least one patch interlayer Ip is a polymer interlayer. Preferably, transparent polymer interlayer can be polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane, an acrylonitrile butadiene styrene copolymer (ABS), a styrene acrylonitrile copolymer (SAN), a styrene methyl methacrylate copolymer (SMMA) and any mixtures of these, a crosslinked resin, an ionoplast, an ionomer, a cyclo-olefin polymer (COP), cyclo-Olefin copolymer (COC) or an Optical Clear Adhesive (OCA).

Crosslinked or cured resins are known to the skilled person and are three dimensional polymer networks obtained by the crosslinking/curing of low molecular weight species either by reaction with a curing agent also known as crosslinker or upon exposure to heat, UV radiations (UV) or electron beam (EB). Non exhaustive examples of crosslinked resins are epoxy resins, polyurethane resins, UV or EB curable resins. In the present invention, the precursors of the crosslinked resin may be transparent or not provided that the crosslinked resin is transparent.

Remark that some polymer mixtures, copolymers and some semi-crystalline polymers can be opaque and non-transparent due to a dispersed phase or due to the presence of crystallites. Hence it is possible that not all compositions of the listed polymers mentioned above are transparent. The person skilled in the art is capable to identify what composition is transparent and hence identify if a given polymer falls within the claimed transparent polymers.

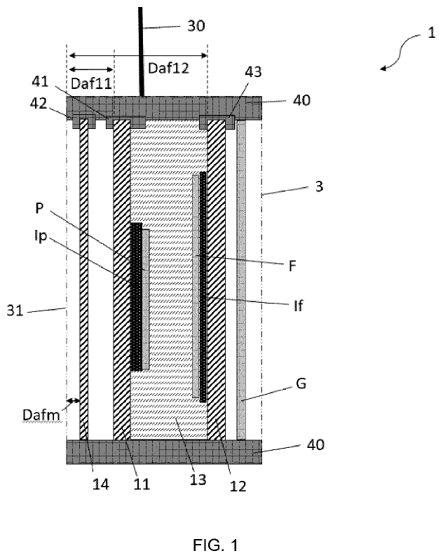

It is understood that the patch network P can be attached to any of the surfaces of the first transparent dielectric panel 11. Preferably the patch network P is attached to the surface opposite to the surface facing the antenna system front face 31 to achieve a higher antenna performance and in parallel to protect the patch network P from the exterior attack, such as moisture, scratches, . . . , as illustrated in FIG. 1.

In some embodiments, the patch network P comprises at least one resonating conductive element. Preferably, the length of the conductive element is equivalent to the half of the effective wavelength at the operation frequency.

Preferably, the dimensions of the surface of the patch network is smaller than the surface of the first transparent dielectric panel.

In some embodiments, several patch networks can be attached to the first transparent dielectric panel to have an antenna system transmitting and/or receipting same or different frequencies. In such embodiments, patch networks are electrically isolated from each other.

The conductive element of the patch network can have any shape such as a rectangular shape. In some embodiments in which the dual-polarized operation is desired, a circular or square shape is preferred. Preferably, the patch network is conductive patch network.

The patch network can be printed, glued, coated on the patch interlayer or placed by any other methods able to non-removably place a patch network on an interlayer on such as screen-printing, inkjet printing, deposition, glued wire, copper foil, copper mesh, etc.

In some embodiments, the patch network can printed, glued, coated on a transparent layer to facilitate the attachment to the first transparent dielectric panel with the patch interlayer and the handling. Such transparent layers are preferably transparent polymer film. Preferably, transparent polymer film can be polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane, an acrylonitrile butadiene styrene copolymer (ABS), a styrene acrylonitrile copolymer (SAN), a styrene methyl methacrylate copolymer (SMMA) and any mixtures of these, a crosslinked resin, an ionoplast, an ionomer, a cyclo-Olefin copolymer (COC), cyclo-Olefin polymer (COP) or an Optical Clear Adhesive (OCA).

Material of the patch network can be metal-based material such as Copper, Silver, conductive metal alloys with or without plated material, such as gold, or any other material able to be electrically conductive and able to be placed on a patch interlayer or on a transparent layer.

The first retaining means 41 retains the first transparent dielectric panel 11 at a defined distance, Daf11, from the front face 31. That means the patch network is also maintain at a defined distance corresponding to the sum between Daf11 and the distance separating the patch network from the calculation point of Daf11 in the first transparent dielectric panel.

The transparent antenna arrangement 10 also comprises a feeding network F attached and separated by at least one feed interlayer If from the second transparent dielectric12.

It is understood that the feeding network F can be attached to any of the surfaces of the second transparent dielectric panel 12. Preferably the feeding network F is attached to the surface facing the first transparent dielectric panel 11 meaning that the surface facing also the antenna system front face 31 to protect the feeding network F from the exterior attack, such as moisture, scratches, . . . , as illustrated in FIG. 1.

In some embodiments, the feeding network comprises at least one conductive element to transfer the signal between the antenna system input and the patch network. Preferably, the width of the feeding network at the input side is in such a way to provide a characteristic impedance of about 50 Ohms.

In some embodiments in which that there are two or more conductive elements in the patch network per each antenna system input, the feeding network can distribute the energy among those above-mentioned conductive elements.

The feeding network can be printed, glued, coated on the feed interlayer or placed by any other methods able to non-removably place a feeding network on an interlayer on such as screen-printing, inkjet printing, deposition, glued wire, copper foil, copper mesh, etc.

In some embodiments, the feeding network can printed, glued, coated on a transparent layer to facilitate the attachment to the second transparent dielectric panel with the feed interlayer and the handling. Such transparent layers are preferably transparent polymer film. Preferably, transparent polymer film can be polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane, an acrylonitrile butadiene styrene copolymer (ABS), a styrene acrylonitrile copolymer (SAN), a styrene methyl methacrylate copolymer (SM MA) and any mixtures of these, a crosslinked resin, an ionoplast, an ionomer, a cyclo-Olefin copolymer (COC), cyclo-Olefin polymer (COP) or an Optical Clear Adhesive (OCA).

Material of the feeding network can be metal-based material such as Copper, Silver, conductive metal alloys with or without plated material, such as gold, or any other material able to be electrically conductive and able to be placed on a feed interlayer or on a transparent layer.

The transparent antenna arrangement 10 also comprises a ground plane G to ensure good and correct functioning of the antenna system.

The location of the ground plane compared to the patch network and the feeding network is important and can affect significantly the performance of the antenna system.

In some embodiments where the ground plane is located between the patch network and the feeding network, the ground plane comprises at least one optimized shaped and sized slot to get the desired performances.

In some embodiments where the feeding network is located between the patch network and the ground, the at least one optimized shaped and sized slot in the ground plane can be absent.

The choice of the configuration is a compromise between complexity and performance.

The ground plane can be printed, glued, coated on a dielectric panel, on a ground interlayer or on a transparent layer or placed by any other methods able to non-removably place a ground plane on a dielectric panel, on a ground interlayer or on a transparent layer such as screen-printing, inkjet printing, deposition, glued wire, copper foil, copper mesh, etc.

In some embodiments, the ground plane is separated by at least one ground interlayer to the second transparent dielectric panel.

In some embodiments, the ground interlayer can be a space filled of gas, such an air gap. The ground plane can be printed, glued, coated on a third transparent dielectric panel or placed by any other methods able to non-removably place a ground plane on a dielectric panel such as screen-printing, inkjet printing, deposition, glued wire, copper foil, copper mesh, etc. In some embodiments, the ground plane can attached and separated by at least one ground interlayer to the third transparent dielectric panel.

In some embodiments, the ground plane is attached and separated by at least one ground interlayer to a third transparent dielectric panel. In such embodiments, the ground interlayer can be a transparent polymer interlayer. In some embodiments, the fourth retaining means can be comprises on the antenna housing to retain the third transparent dielectric panel.

The ground plane can printed, glued, coated on a transparent layer to facilitate the attachment to the second or a third transparent dielectric panel with the ground interlayer and the handling. Such transparent layers are preferably transparent polymer film. Preferably, transparent polymer film can be polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane, an acrylonitrile butadiene styrene copolymer (ABS), a styrene acrylonitrile copolymer (SAN), a styrene methyl methacrylate copolymer (SMMA) and any mixtures of these, a crosslinked resin, an ionoplast, an ionomer, a cyclo-Olefin copolymer (COC), cyclo-Olefin polymer (COP) or an Optical Clear Adhesive (OCA).

Material of the ground plane can be metal-based material such as Copper, Silver, conductive metal alloys with or without plated material, such as gold, or any other material able to be electrically conductive and able to be placed on a ground interlayer or on a transparent layer.

In some preferred embodiments, as for the patch network and the feeding network, to ensure the conductivity and transparency, the ground plane can be designed using a Cu-mesh on the top of a transparent layer such as a PET layer.

In some embodiments, other transparent layers can be used to separate, to assemble and to laminate at least the patch network, the feeding network and/or the ground plane to the first and/or the second transparent dielectric panel and/or a third transparent dielectric panel if exists. These layers are preferably transparent polymers.

Preferably, the transparent layers are low-loss transparent layers to reduce the losses of the antenna system.

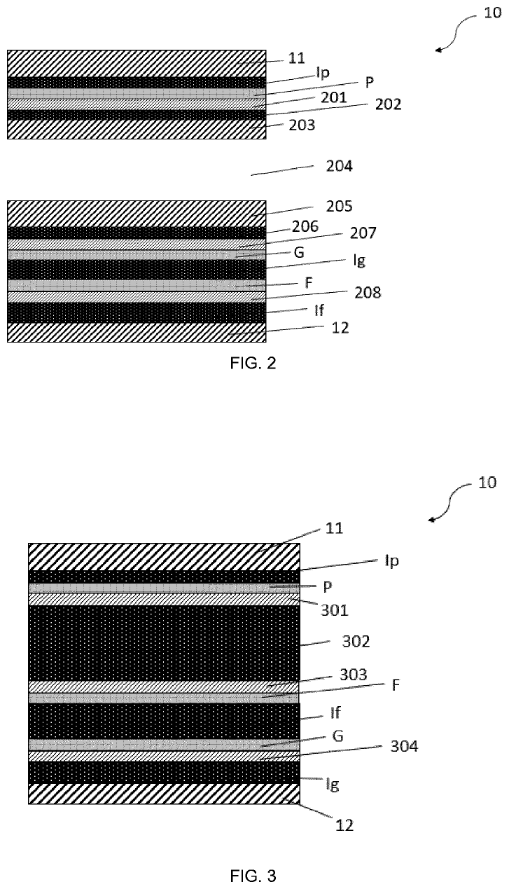

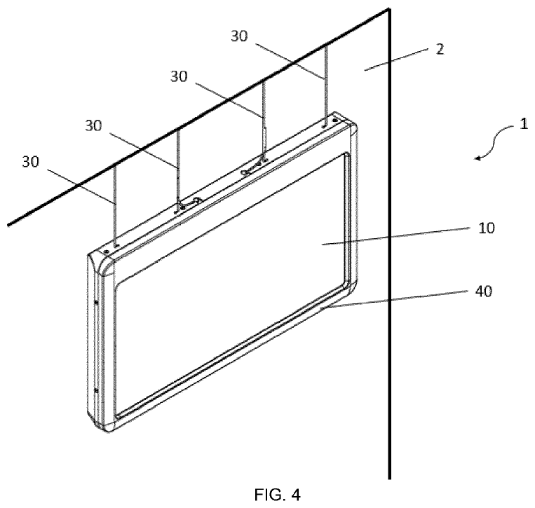

FIGS. 2 and 3 illustrate some embodiments of a transparent antenna arrangement according to the invention in which some layers are used to separate, to assemble and to laminate the patch network, the feeding network and/or the ground plane to the first and/or the second transparent dielectric panel.

In one embodiment, as illustrated in FIG. 2, the transparent antenna arrangement 10 comprises a patch network P attached to and separated from the first transparent dielectric panel 11, a glass panel, by a patch interlayer Ip. The patch interlayer is a COC or a COP. A PET layer 201 then a COP layer 202 and a glass layer 203 is attached to the patch network P to facilitate the handling and to protect the patch network P. The patch network P is laminated on the first transparent dielectric panel 11 with patch interlayer Ip and the layers 201, 202 with the glass panel 203.

The patch network P, the feeding network F and the ground plane G are individually assembled on a transparent layer 201, 207, 208 to facilitate the attachment to the corresponding transparent dielectric panel. Preferably, these transparent layers are PET layers.

The transparent antenna arrangement 10 comprises a feeding network F attached to and separated by from the second transparent dielectric panel 12 at a feed interlayer If and a PET layer 207. The feed interlayer If is a cyclo-Olefin polymer. The ground plane G is attached to the second transparent dielectric panel 12 by a ground interlayer Ig. The ground plane G is located between the feeding network F and the first transparent dielectric panel 11. There is a PET layer 207 between the ground interlayer Ig and the feeding network F, meaning that the feeding network F is laminated between the feed interlayer If and the PET layer 207. To protect the ground plane G and the feeding network F, a PET layer 208, a COP layer 206 and a glass layer 205 is attached to the second transparent dielectric panel 12. The feeding network F and the ground plane G are laminated together with the feed interlayer If, the ground interlayer Ig to the second transparent dielectric panel 12. Preferably, when the ground plane G is positioned between the feeding network and the patch network, the ground plane comprises at least one slot.

This is understood that PET layers 201, 207, 208, COP layers 202, 206 and/or glass layer 203, 205 can be absent or made with another composition.

The first 11 and the second 12 transparent dielectric panels are separated by a panel interlayer 204. The panel interlayer 204 is a space filled by a gas, preferably an air gap. The thickness of the air gap is defined to optimize a minimal distance to increase the coupling performances between the patch network and the feeding network and a maximal distance to increase the wide band performances of the antenna arrangement.

In this embodiments, the housing of the antenna system can retain the first and the second transparent dielectric panels independently meaning that the air gap can be modified or defined modifying the defined distances Daf11 and Daf12 independently to optimize the transmission and the reception of the antenna system.

Table 1 illustrates an embodiment with specific thicknesses, in millimeters and measured in the normal direction of the main surface, of the different layers illustrated in FIG. 2 optimizing the reception and/or the transmission of the antenna system for LTE B1 and LTE B3. It is understood that different thickness values can be used for the same bands or for different bands.

TABLE 1

| Layer | Thickness [mm] |
|---|---|
| 11 | 2.0 |
| Ip | 0.4 |
| P | 0.1 |
| 201 | 0.1 |
| 202 | 0.4 |
| 203 | 0.7 |
| 204 | 4.8 |
| 205 | 0.7 |
| 206 | 0.4 |
| 207 | 0.1 |
| G | 0.1 |
| Ig | 0.8 |
| F | 0.1 |
| 208 | 0.1 |
| If | 0.4 |
| 12 | 1.1 |

FIG. 3 shows an another embodiment of an antenna arrangement 10 of an antenna system according to the invention.

The first 11 and the second 12 transparent dielectric panels are separated by a panel interlayer 302. The panel interlayer 302 is a transparent polymer interlayer, a cyclo-Olefin polymer meaning that the first and the second first 11 and the second 12 transparent dielectric panels are laminated together by the panel interlayer 302. The thickness of the panel interlayer is defined to optimize a minimal distance to increase the coupling performances between the patch network and the feeding network while a maximal distance to increase the wide band performances of the antenna arrangement.

In such embodiments, only the defined distance Daf11 and the defined distance Daf12 are adapted with the antenna housing with the same difference because the first and the second transparent dielectric panels are laminated together by a fixed thickness.

The feeding network F is located between ground plane G and the second transparent dielectric panel 12.

The patch network P, the feeding network F and the ground plane G are individually assembled on a transparent layer 301, 303, 304. Preferably these transparent layers are PET layers. The patch network P is attached to the first transparent dielectric panel 11 by the patch interlayer Ip. PET layers with the part of the antenna arrangement, the patch network, the feeding network or the ground plane, are laminated together with the first 11 and the second 12 transparent dielectric panels with interlayers and layers with the patch network, the feed, the ground and the panel interlayers meaning that the patch network P, the feeding network F and the ground plane G are laminated together between the first 11 and the second 12 transparent dielectric panels with respectively the patch network, the feed and the ground interlayers and layers.

Table 2 illustrates a embodiment with specific thicknesses, in millimeters and measured in the normal direction of the main surface, of the different layers illustrated in FIG. 3 optimizing the reception and the transmission of the antenna system for LTE B42, LTE B43, 5G NR n77 and/or 5G NR n78. It is understood that different thickness values can be used for the same bands or for different bands.

TABLE 2

| Layer | Thickness [mm] |
|---|---|
| 11 | 1.1 |
| Ip | 0.4 |
| P | 0.1 |
| 301 | 0.1 |
| 302 | 1.6 |
| 303 | 0.1 |
| F | 0.1 |
| If | 0.8 |
| G | 0.1 |
| 304 | 0.1 |
| Ig | 0.4 |
| 12 | 1.1 |

The thicknesses of the first and the second transparent dielectric panels can be different. The thickness can depend of the composition to increase the antenna system efficiency.

In some embodiments, when the first and the second dielectric panels are glass panels, the thicknesses are equal to or higher than 0.05 mm, preferably the thicknesses are equal to or higher than 0.5 mm and more preferably the thicknesses are equal to or higher than 1 mm, and the thicknesses are equal to or smaller than 4 mm, preferably the thicknesses are equal to or smaller than 3 mm, and more preferably the thicknesses are equal to or smaller than 2 mm.

In some preferred embodiments, retaining means are notches and/or slides on the antenna frame. Said notch can have a thickness, measured parallel to the normal of the antenna system front face, at least equals to the thickness of the corresponding panel, with the attached layers, interlayer and part of the antenna arrangement, to be inserted in.

In some embodiments, the thickness of the notches is higher than the thickness of the corresponding panel, with the attached layers, interlayer and part of the antenna arrangement, to be inserted in. In such embodiment, a clamping means can be add to firmly retain the corresponding panel. In such embodiments, the defined distance Daf11, Daf12 and/or Dafm can be adapted by modifying the position of the clamping means or by adapting the thickness of the panel.

As the patch network is attached to the first transparent dielectric panel, the defined distance Daf11 regulates the distance between the patch network and the antenna system front frame.

As the feeding network is attached to the second transparent dielectric panel, the defined distance Daf12 regulates the distance between the feeding network and the antenna system front frame and between the patch network and the feeding network. The distance between the patch network and the feeding network can be managed by the panel interlayer and/or the first and the third retaining means to optimize the antenna system performances. In some embodiments, the distance between the patch network and the feeding network is managed by the thickness of the panel interlayer. This thickness can be managed by modifying the thickness of at least one panel, interlayer, layer of the antenna arrangement and/or by modifying the thickness of the transparent panel polymer interlayer or the space filled by a gas. Preferably, depending of the operating frequency, the distance between the patch network and the feeding network is comprises between 1 mm and 10 mm, preferably between 3 mm and 7 mm, and more preferably between 4.8 mm and 6.8 mm.

In some embodiments where the installation interface panel exists, the defined distance Dafm between the installation interface panel and the antenna system front frame regulates the distance between the installation interface panel and the patch network and/or the feeding network.

FIGS. 4 to 8 illustrates an antenna system 1 mounted on a window 2.

The window 2 can be a window used as a window to close an opening of the stationary object, such as a building, or to close an opening of the mobile object, such a train, a boat, . . .

Windows are usually multi-glazed windows to increase thermal performances of the window.

The multi-glazed window 2 can be at least partially transparent to visible waves for visibility, and natural or artificial light. The multi-glazed window is made of multiple panels separated by at least one interlayer, forming multiple interfaces. The panels therefore can be separated by a space filled with gas and/or by a polymeric interlayer.

In some embodiments, the multi-glazed window 2 can comprise at least two glass panels separated by a spacer allowing to create a space filled by a gas like Argon to improve the thermal isolation of the multi-glazed window, creating an insulating multi-glazed window. The invention is not limited to apparatus for use on multi-glazed window having two panels. The apparatus and method of the present invention are suitable for any multi-glazed window such as double, triple glazed windows.

In some embodiments, the glass panel can be a laminated multi-glazed window such as those to reduce the noise and/or to ensure the penetration safety. The laminated glazing comprises panels maintained by one or more interlayers positioned between glass panels. The interlayers are typically polyvinyl butyral (PVB) or ethylene-vinyl acetate (EVA) for which the stiffness can be tuned. These interlayers keep the glass panels bonded together even when broken in such a way that they prevent the glass from breaking up into large sharp pieces.

Said panels of the multi-glazed window can be made of glass, polycarbonate, PVC or any other material used for a window mounted on a stationary object or on a mobile object.

Usually, the material of the panels of multi-glazed window 2 is, for example, soda-lime silica glass, borosilicate glass, aluminosilicate glass or other materials such as thermoplastic polymers or polycarbonates which are especially known for automotive applications. References to glass throughout this application should not be regarded as limiting.

The multi-glazed window 2 can be manufactured by a known manufacturing method such as a float method, a fusion method, a redraw method, a press molding method, or a pulling method. As a manufacturing method of the multi-glazed window, from the viewpoint of productivity and cost, it is preferable to use the float method.

Each panel can be independently processed and/or colored, . . . and/or have different thickness in order to improve the aesthetic, thermal insulation performances, safety, . . . The thickness of the multi-glazed window 2 is set according to requirements of applications.

The multi-glazed window 2 can be any known window used in situ. For example, the multi-glazed window 2 can be processed, ie annealed, tempered, . . . to respect the specifications of security and anti-thief requirements. The window can independently be a clear glass or a colored glass, tinted with a specific composition of the glass or by applying an additional coating or a plastic layer for example. The window can have any shape to fit to the opening such as a rectangular shape, in a plan view by using a known cutting method. As a method of cutting the multi-glazed window, for example, a method in which laser light is irradiated on the surface of the multi-glazed window to cut the multi-glazed window, or a method in which a cutter wheel is mechanically cutting can be used. The multi-glazed window can have any shape in order to fit with the application, for example a windshield, a sidelite, a sunroof of an automotive, a lateral glazing of a train, a window of a building, . . .

The shape of the multi-glazed window in a plan view is usually a rectangle. Depending of the application, the shape is not limited to a rectangle and may be a trapeze, especially for a windshield or a backlite of a vehicle, a triangle, especially for a sidelight of a vehicle, a circle or the like.

In addition, the multi-glazed window can be assembled within a frame or be mounted in a double skin façade, in a carbody or any other means able to maintain a multi-glazed window. Some plastics elements can be fixed on the multi-glazed window to ensure the tightness to gas and/or liquid, to ensure the fixation of the multi-glazed window or to add external element to the multi-glazed window. In some embodiments, a masking element, such as an enamel layer, can be added on part of the periphery of the multi-glazed window.

For thermal comfort inside the stationary object or mobile object, a coating system can be present on one interface of the multi-glazed window. This coating system generally uses a metal-based layer and infrared light is highly refracted by this type of layer. Such coating system is typically used to achieve a to a low-energy multi-glazed window.

In some embodiment, the coating system can be a heatable coating applied on the multi-glazed window to add a defrosting and/or a demisting function for example and/or to reduce the accumulation of heat in the interior of a building or vehicle or to keep the heat inside during cold periods for example. Although coating system are thin and mainly transparent to eyes.

Usually, the coating system is covering most of the surface of the interface of the multi-glazed window 2.

The coating system can be made of layers of different materials and at least one of these layers is electrically conductive. In some embodiments, for example in automotive windshields, the coating system can be electrically conductive over the majority of one major surface of the multi-glazed window. This can causes issues such as heated point if the portion to be decoating is not well designed.

A suitable coating system is for example, a conductive film. A suitable conductive film, is for example, a laminated film obtained by sequentially laminating a transparent dielectric, a metal film, and a transparent dielectric, ITO, fluorine-added tin oxide (FTO), or the like. A suitable metal film can be, for example, a film containing as a main component at least one selected from the group consisting of Ag, Au, Cu, and Al.

The coating system may comprise a metal based low emissive coating system. Such coating systems typically are a system of thin layers comprising one or more, for example two, three or four, functional layers based on an infrared radiation reflecting material and at least two dielectric coatings, wherein each functional layer is surrounded by dielectric coatings. The coating system of the present invention may in particular have an emissivity of at least 0.010. The functional layers are generally layers of silver with a thickness of some nanometers, mostly about 5 to 20 mm. The dielectric layers are generally transparent and made from one or more layers of metal oxides and/or nitrides. These different layers are deposited, for example, by means of vacuum deposition techniques such as magnetic field-assisted cathodic sputtering, more commonly referred to as “magnetron sputtering”. In addition to the dielectric layers, each functional layer may be protected by barrier layers or improved by deposition on a wetting layer.

In some embodiments, to maximize the transmission and the reception of the antenna system in front of a window having a coating system, a decoated portion can be made in front of the antenna to alleviate attenuation due to the coating system.

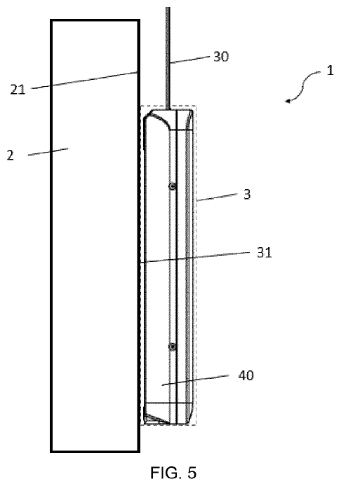

FIGS. 4 and 5 illustrate an antenna system comprising an antenna housing 40.

The antenna system 1 is inscribed in a parallelepiped 3 mainly defined by the extremities of the antenna housing around the first and the second transparent dielectric panels. Preferably, the antenna system front face 31 corresponds to the surface 21 of the window 2 meaning that at least a portion of the antenna housing is in contact with the surface 21 of the window 2. This permits to retain panels at the corresponding defined distance even if the antenna system is not placed against the window. Thus, it is possible to define the configuration of the window and then adapt the defined distances to optimize the transmission and/or the reception of an antenna system.

The defined distances are measured from the antenna system front face 31 to a point of the corresponding first transparent dielectric, the second transparent dielectric or installation interface panel. The measurement position on the first transparent dielectric, the second transparent dielectric and/or installation interface panel is preferably taken from the surface facing the antenna system front face.

The antenna frame 40 comprises a maintaining means 30 to maintain the antenna system in front of a window 2.

In some embodiments, the maintaining means 30 can be glue, double faced tape, suction pad or any other means to fix an antenna system on a surface 21 of a window 2.

Preferably, the maintaining means comprises a hanging means 30 to hang the antenna system in front of the window 2 while insuring the security of the installation. The antenna system is hanged and the antenna housing can comprises a means to avoid scratches on the surface of the window. The hanging means comprises preferably at least one cable, preferably at least two cables, to hang the antenna system in front of the window.

The antenna frame can comprise a frame surrounding 40 at least partially the first transparent dielectric panel and the second transparent dielectric panel. Preferably, the frame surrounds the first transparent dielectric panel, the second transparent dielectric panel, the installation interface panel if exists and the third transparent dielectric panel if exists.

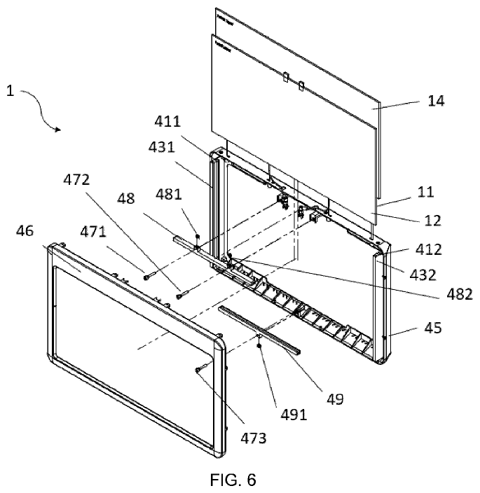

FIG. 6 illustrates an embodiment where the first 11 and the second 12 transparent dielectric panels separated by an panel interlayer and an installation interface panel 14.

The antenna housing comprises a fixing part 45 and a cover part 46. The fixing part and the cover part are assembled by any known manner such as by clipping, screwing, gluing or a mix manner. The fixing part comprises a first retaining means 41 and a third retaining means 43. The first retaining means 41 comprises two 411, 412 slides in which the first transparent dielectric 11 panel is slipped. The third retaining means 43 comprises two slide 421, 422 slides in which the second transparent dielectric 12 panel is slipped.

As illustrated in FIG. 6, the antenna housing can comprise a second retaining means. In this embodiment, the second retaining means comprises two clams 48, 49; each clam comprises at least a means 481, 491 to bring the installation interface panel closer and/or away from the antenna system front face. In order to adapt the parallelism between installation interface panel and antenna system front face, one of the clams 48 comprises two means 481, 482 and the second clam 49 comprises one means 491 in order to ensure a displacement of the clams allowing a parallelism of the installation interface panel. Such means can be a nut fixed to the clam. A screw 471, 472, 473, corresponding to the dedicated nut 481, 482, 491, is fixed to the antenna housing, preferably fixed to the fixed part of the antenna housing 45. When at least one of the screws is screwed or unscrewed, the clamp is displaced closer and/or away from the antenna system front face. By turning one screw, the installation interface panel is reoriented to change its parallelism, the nut is moving on the screw and drives the displacement of the clam and then the installation interface panel. By turning more than one screw, the installation interface panel is displaced closer and/or away from the antenna system front face and modifying the defined distance Dafm. In order to modify the defined distance Daf11 and/or Daf12, retaining means can comprises a mobile part. The mobile part permits to displace the panel in order to adapt the defined distance to optimize the reception and the transmission of the antenna system depending of the configuration, such as thickness, material, composition, . . . , of the window in front of the antenna system.

The advantage of such embodiments is to allow to adjust parameters of the antenna system such as Daf11, Daf12, Dafm, parallelism between panels and/or antenna system front face independently to cancels out the impact of the installation medium/media on the antenna system performance and permits to maintain the impedance response of the antenna as well as the radiation properties of the antenna within the specifications.

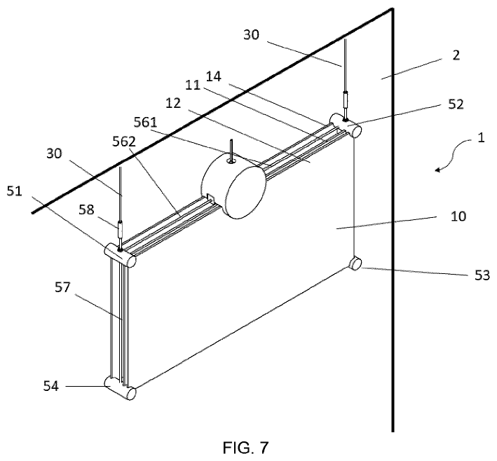

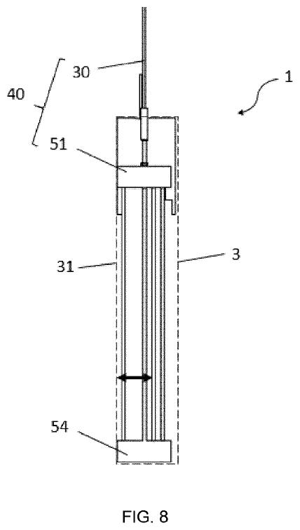

FIGS. 7 and 8 illustrates another embodiments. This embodiment permits to have a better visual transparency while keeping the antenna system performances and security.

The antenna system 1 comprises a installation interface panel 14 in front of the window 2. The antenna system 1 comprises a first 11 and a second 12 transparent dielectric panels. Said panels can be separated by an air gap or by an polymer interlayer.

The installation interface panel 14 and the first 11 and the second 12 transparent dielectric panels are secured parallel to each other in the antenna housing. The antenna housing comprises four corner elements in which the first retaining means is integrated.

Preferably, the four corners comprises a second retaining means and more preferably the four corners further comprises a third retaining means to adapt the corresponding defined distance.

The antenna system 1 is inscribed in a parallelepiped 3 mainly defined by the extremities of the four corners. Preferably, the antenna system front face 31 corresponds to the surface 21 of the window 2 meaning that at least a portion of the antenna housing is in contact with the surface 21 of the window 2. This permits to retain panels at the corresponding defined distance even if the antenna system is not placed against the window. Thus, it is possible to define the configuration of the window and then adapt the defined distances to optimize the transmission and/or the reception of an antenna system.

The defined distances are measured from the antenna system front face 31 to a point of the corresponding first transparent dielectric, the second transparent dielectric or installation interface panel. The measurement position on the first transparent dielectric, the second transparent dielectric and/or installation interface panel can be taken in any position as long as this measurement position always remains the same on the panel.

The antenna housing comprises a maintaining means 30. Preferably the maintaining means comprises at least a cable to hang the antenna system in front of the window and in contact with the window.

Preferably, the antenna housing comprises a tightening means 561, 562, 57 between the four corner elements 51 to tighten the corner elements while securing the first and the second transparent dielectric panels in the antenna system.

Preferably, the tightening means comprises cables connecting corner elements. A cable 57 is fixed on the bottom corner element 54 and the cable 57 passes through the top corner element 51 while attached to it. Preferably, the maintaining means comprises a system 57 to secure the tightening means and the maintaining means together. The end of the cable 57 is attached to the handing means 30 through a attaching means 58. It is understood that the cable 57 and the hanging means 30 can be a single element. Between the two top corner elements 51, 52 and between the two bottom corner elements 54, 53, the tightening means can comprises cables 561, 562 (not shown for tightening means between the bottom corner elements). One end of said cables 561, 562 is fixed to the respective corner element 51, 52. The second end of the cables are fixed together with a clamping means to clamp panels.

Preferably, cables can have a dimeter comprises between 0.5 and 3 mm and more preferably around 2 mm.

Preferably, corner elements have a diameter of about 20 mm and a length comprises between 30 and 60 mm, preferably between 40 and 50 mm.

In some embodiments, a fixing means, such as glue, double faced tape or any other known fixing means, can be added to the corner elements in front of the antenna system front face to fix the antenna system on a surface of a window.

Preferably, retaining means are integrated on the corner elements.

In some preferred embodiments, retaining means are notches on the corner elements. Said notch can have a thickness, measured parallel to the normal of the antenna system front face, at least equals to the thickness of the corresponding panel, with the attached layers, interlayer and part of the antenna arrangement, to be inserted in.

In some embodiments, the thickness of the notches is higher than the thickness of the corresponding panel, with the attached layers, interlayer and part of the antenna arrangement, to be inserted in. In such embodiment, a clamping means can be add to firmly retain the corresponding panel. In such embodiments, the defined distance Daf11, Daf12 and/or Dafm can be adapted by modifying the position of the clamping means or by adapting the thickness of the panel.

This embodiment can seems less adjustable than the previous embodiment. By adding adjustable means, such as screws, adjustable bars on at least some corner elements, this allows to adjust parameters of the antenna system such as Daf11, Daf12, Dafm, parallelism between panels and/or antenna system front face independently.

1. An antenna system inscribed in a parallelepiped with an antenna system front face, comprising:
a first transparent dielectric panel in front of the antenna system front face;
a second transparent dielectric panel in front of the first transparent dielectric panel and separated by at least one panel interlayer from the first transparent dielectric panel;
a transparent antenna arrangement comprising
a patch network attached and separated by at least one patch interlayer from the first transparent dielectric panel;
a feeding network attached and separated by at least one feed interlayer from the second transparent dielectric panel; and
a ground plane; and
an antenna housing,
wherein the antenna housing comprises a first retaining means to retain the first transparent dielectric panel at a defined distance, Daf11, from the front face and in that the at least one patch interlayer is a transparent polymer interlayer.

2. The antenna system according to claim 1, wherein the antenna system comprises an installation interface panel located between the first dielectric panel and the antenna system front face.

3. The antenna system according to claim 2, wherein the antenna housing comprises a second retaining means to retain the installation interface panel at a defined distance, Dafm, from the antenna system front face.

4. The antenna system according to claim 1, wherein the ground plane is separated by at least one ground interlayer to the second transparent dielectric panel.

5. The antenna system according to claim 1, wherein the ground plane is located between the feeding network and the second transparent dielectric panel.

6. The antenna system according to claim 1, wherein the ground plane is located between the feeding network and the first transparent dielectric panel.

7. The antenna system according to claim 1, wherein the at least one panel interlayer is a transparent polymer interlayer.

8. The antenna system according to claim 1, wherein the at least one panel interlayer is a space filled by a gas.

9. The antenna system according to claim 8, wherein the antenna housing comprises a third retaining means to retain the second transparent dielectric panel at a defined distance, Daf12, from the antenna system front face.

10. The antenna system according to claim 9, wherein the first and/or the second and/or the third retaining means comprises an adjustable means to modify the defined distance between the antenna system front face and respectively the first transparent dielectric panel, a matching panel and the second transparent dielectric panel.

11. The antenna system according to claim 1, wherein the antenna housing comprises a frame surrounding the first transparent dielectric panel and the second transparent dielectric panel.

12. The antenna system according to claim 1, wherein the antenna housing comprises a corner element in which the first retaining means is integrated.

13. The antenna system according to claim 12, wherein the antenna housing comprises four corner elements in which the first retaining means is integrated.

14. The antenna system according to claim 13, wherein the antenna housing comprises a tightening means between the four corner elements to tighten the four corner elements.

15. The antenna system according claim 1, wherein the antenna housing comprises a maintaining means to maintain the antenna system in front of a window.

16. The antenna system according to claim 1, wherein the antenna housing comprises two corner elements in which the first retaining means is integrated.

17. The antenna system according to claim 1, wherein the antenna housing comprises three corner elements in which the first retaining means is integrated.
